(19) United States
(12) Patent Application Publication
(10) Pub. No.: US 2025/0148191 A1
(43) Pub. Date: May 8, 2025

(54) KEYWORD EXTRACTION TO GENERATE SUBJECT LINES

(71) Applicant: Shopify Inc., Ottawa (CA)

(72) Inventors: Clare CURTIS, Toronto (CA); Morgan AUBERT, Montreal (CA); Natalie HERCUN, Montreal (CA); Vibhor MALIK, San Francisco, CA (US)

(21) Appl. No.: 18/501,444

(22) Filed: Nov. 3, 2023

(51) Int. Cl. G06F 40/166; G06F 40/40; G06N 3/0455

(52) U.S. Cl. CPC G06F 40/166; G06F 40/40; G06N 3/0455

(57) ABSTRACT

Methods and systems for prompting a large language model (LLM) to generate a subject line for a body of text are disclosed. An original list of keywords based on a body of text is obtained using a trained machine learning model. A prompt to the LLM is then generated for generating the subject line, where the prompt includes a chosen list of keywords that is based on the original list of keywords. The prompt does not include the body of text. Responsive to the prompt, at least one generated subject line corresponding to the body of text is obtained from the LLM.

### FIELD

The present disclosure is related to generation of prompts to a large language models (LLM), and, more particularly, to prompting the LLM to generate a subject line based on a body of text using keywords extracted from the body of text, for example the keywords may be extracted using another machine learning model.

### BACKGROUND

When using a machine learning model to summarize a body of text, current models are very effective at generating a summary in a particular tone, such as for copywriting purposes. If the machine learning model is prompted multiple times with the same prompt having the same body of text, the machine learning model may summarize the text differently each time, usually within a range of variability. Thus, it is difficult to predict with accuracy exactly what the machine learning model will output even when given the same prompt multiple times. Therefore, if a particular summary is desired (such as one that focuses on a specific aspect of the body of text), the prompt must be changed (such as by changing the body of text that is included in the prompt). However, it may be difficult to predict how a given change to the body of text will affect the summary outputted by the machine learning model. Thus, using a machine learning model to generate a desired summary of a body of text can be time consuming, cumbersome, and several iterations may be required, which can result in consumption of significant processing power and other computing resources.

### SUMMARY

In various examples, the present disclosure describes a technical solution that uses a two-step approach to generate a subject line (or title, or any other form of short summary) from a body of text with one or more large language models (LLMs), which may provide greater control over the subject line or title outputted by a LLM. Keywords are generated from the body of text (e.g., using a machine learning model such as a text summarizer) and the keywords are then used in a prompt to a LLM to generate the subject line. Examples of the present disclosure provide the technical advantage that the LLM can be prompted to generate an acceptable subject line from a body of text with fewer prompts, thus reducing the use of computing resources (e.g., memory, communication bandwidth, etc.). Further, the prompt to the LLM may be shorter because the full body of text is not included in the prompt, which may help to reduce the processing power required at the LLM.

The use of keywords in the prompt to the LLM, rather than the entire body of text, may help to prevent hallucinations and drift in the generated output. For example, the subject line generated by the LLM may be less influenced by irrelevant properties or parameters of the body of text, such as the length of the body of text. As well, the machine learning model used to generate the keywords may be separate from the LLM used to generate the subject line, thus each model used can be selected to be more efficient or better suited to their particular task. This can also help to speed up and/or reduce the computational cost of the overall process of multiple subject line generation.

The present system and method could, for example, be used to generate subject lines for emails, create newspaper headlines, journal article titles, blog or social media post headings, etc.

In some examples, the present disclosure describes a system comprising: a processing unit configured to execute instructions to cause the system to: obtain an original list of keywords based on a body of text using a first large language model (LLM); generate a prompt to a second LLM for generating a subject line, the prompt including a chosen list of keywords based on the original list of keywords, wherein the prompt does not include the body of text; and obtain, from the second LLM responsive to the prompt, at least one generated subject line corresponding to the body of text.

In an example of the preceding system, the processing unit is further configured to provide the original list of keywords to a user device, wherein the user device is configured to present the original list of keywords as suggestions.

In an example of the preceding system, the processing unit is further configured to receive the chosen list of keywords from the user device.

In an example of the preceding system, the chosen list of keywords is the original list of keywords or includes at least some of the keywords from the original list of keywords.

In an example of the preceding system, the processing unit is further configured to: provide the at least one generated subject line to a user device for presentation; receive a revised list of keywords from the user device; generate another prompt to the LLM for generating another subject line, the prompt including the revised list of keywords, wherein the prompt does not include the body of text; and obtain, from the LLM, another at least one generated subject line.

In an example of the preceding system, the processing unit is further configured to: provide the chosen list of keywords with the at least one generated subject line to the user device for presentation.

In an example of the preceding system, the processing unit is further configured to: save the at least one generated subject line in memory; and provide the at least one generated subject line and the other at least one generated subject line to the user device for presentation.

In an example of the preceding system, the the processing unit is further configured to: provide the at least one generated subject lines to a user device for presentation; provide feedback options for the at least one generated subject line to the user device for presentation; and receive feedback from the user device.

In an example of the preceding system, the prompt further includes one or more of historical email data, business information, and user demographic information associated with the user.

In an example of the preceding system, the trained machine learning model is a text summarizer that uses natural language processing (NLP) techniques.

In some examples, the present disclosure describes a computer-implemented method comprising obtaining an original list of keywords based on a body of text using a trained machine learning model; generating a prompt to a large language model (LLM) for generating a subject line, the prompt including a chosen list of keywords based on the original list of keywords, wherein the prompt does not include the body of text; and obtaining, from the LLM responsive to the prompt, at least one generated subject line corresponding to the body of text.

In an example of the preceding method, the method further comprises providing the original list of keywords to a user device, wherein the user device is configured to present the original list of keywords as suggestions.

In an example of the preceding method, the method further comprises receiving the chosen list of keywords from the user device.

In an example of the preceding method, the chosen list of keywords is the original list of keywords or includes at some of the keywords from the original list of keywords.

In an example of the preceding method, method further comprises providing the chosen list of keywords with the at least one generated subject line to the user device for presentation.

In an example of the preceding method, the method further comprises providing the at least one generated subject line to a user device for presentation; receiving a revised list of keywords from the user device; generating another prompt to the LLM for generating another subject line, the prompt including the revised list of keywords, wherein the prompt does not include the body of text; and obtaining, from the LLM, another at least one generated subject line.

In an example of the preceding method, the method further comprises saving the at least one generated subject line in memory; and providing the at least one generated subject line and the other at least one generated subject line to the user device for presentation.

In an example of the preceding method, the method further comprises providing the at least one generated subject lines to a user device for presentation; providing feedback options for the at least one generated subject line to the user device for presentation; and receive feedback from the user device.

In an example of the preceding method, the prompt further includes one or more of historical email data, business information, and user demographic information associated with the user device.

In some examples, the present disclosure describes a computer-readable medium storing instructions that, when executed by a processor of a computing system, cause the computing system to obtain an original list of keywords based on a body of text using a trained machine learning model; generate a prompt to a large language model (LLM) for generating a subject line, the prompt including a chosen list of keywords based on the original list of keywords, wherein the prompt does not include the body of text; and obtain, from the LLM responsive to the prompt, at least one generated subject line corresponding to the body of text.

In some examples, the computer-readable medium may store instructions that, when executed by the processor of the computing system, cause the computing system to perform any of the methods described above.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system including a prompt generation engine and a subject line module, which may be used to implement examples of the present disclosure;

FIG. 3 is a flowchart illustrating a method for generating subject lines according to examples of the present disclosure;

FIG. 4 is a block diagram of an example e-commerce platform including the prompt generation engine and the subject line module of FIG. 2, which may be an example implementation of the examples disclosed herein;

FIG. 5 is an example homepage of an administrator, which may be accessed via the e-commerce platform of FIG. 4; and

FIG. 6 is another block diagram of the example e-commerce platform, the subject line module, and the prompt generation engine of FIG. 4 showing details related to the prompt generation engine and the subject line module according to an embodiment.

Similar reference numerals may have been used in different figures to denote similar components.

### DETAILED DESCRIPTION

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections and skip connections, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used for ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject specific corpus may be created by extracting text from online webpages and/or publicly available social media postings. In another example, to train a ML model that is intended to classify images, the training dataset may be a collection of images. Training data may be annotated with a ground truth label or may be unlabeled.

Training a ML model generally involves inputting training data to be processed by the ML model, processing the training data by the ML model, collecting the output generated by the ML model and comparing the output to a desired target value. If the training data is labeled, the desired target value may be the ground truth label of the training data. If the training data is unlabeled, the desired target value may be to reconstruct the target data (e.g., in the case of an autoencoder) or some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the predicted value is to the target value. An objective function represents a quantity to be optimized (e.g., minimize a loss or maximize a reward) in order to bring the predicted value as close to the target value as possible. The goal of training the ML model typically is to minimize a loss function or maximize a reward function.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task.

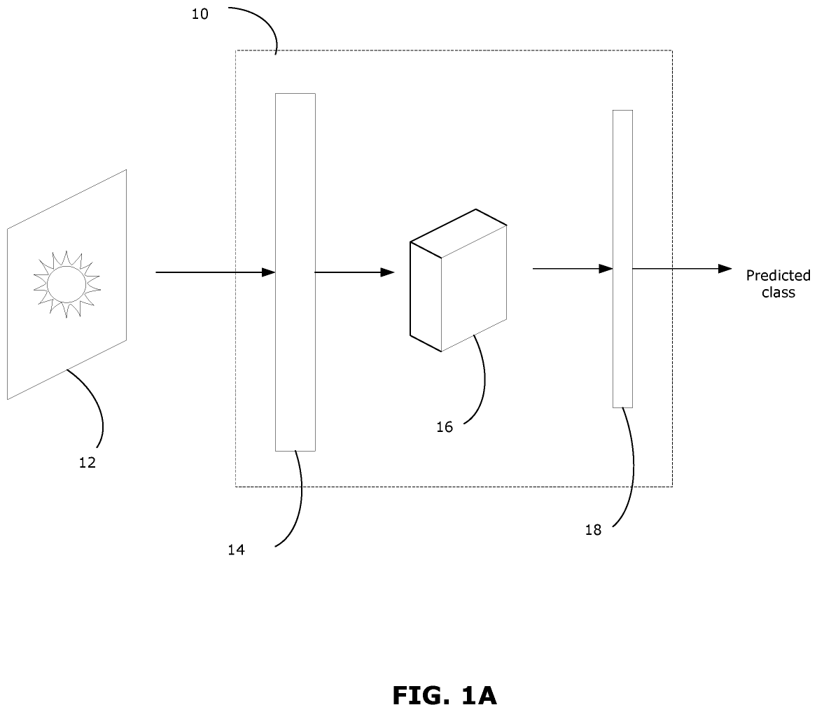

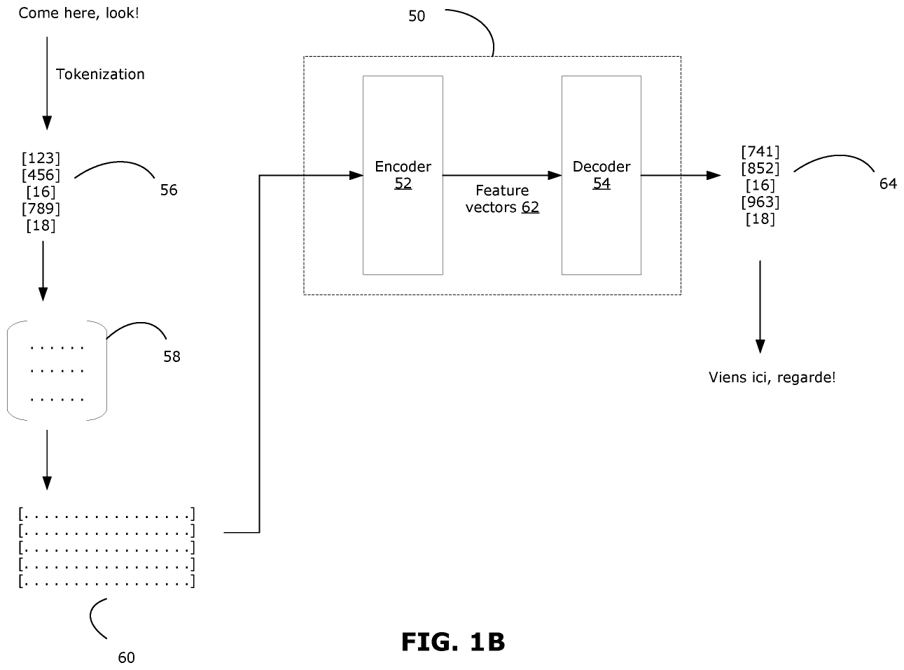

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that processes the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a feature map 16 (sometimes referred to as an activation map). The feature map 16 generally has smaller width and height than the image 12 but has greater depth (where depth corresponds to the feature dimension). The feature map 16 encodes image features that may be processed by subsequent layers of the CNN 10, depending on the design and intended task for the CNN 10. In this example, a fully connected layer 18 processes the feature map 16 in order to perform a classification of the image, based on the features encoded in the feature map 16. The fully connected layer 18 contains learned parameters that, when applied to the feature map 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction and natural language generation, among others. A language model may be trained to learn parameters in order to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) model are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined by the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. The vector space may be defined by the dimensions and values of the embedding vectors. For example, the embedding 60 corresponding to [look] will be closer to another embedding corresponding to [see] in the vector space, as compared to the distance between the embedding 60 corresponding to [look] and another embedding corresponding to [cake]. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are inputted to the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and uses auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions) and is able to accept a large number of tokens as input (e.g., up to 2048 input tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations) to generate chat-like text output. ChatGPT is designed for processing natural language, chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as may be, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is processed into a token sequence and provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. This type of learning done by the LLM is referred to as one-shot learning or few-shot learning, depending on how many examples are given in the prompt. A one-shot prompt refers to a prompt that includes one example and a few-shot prompt refers to a prompt that includes multiple examples. A prompt that includes no examples may be referred to as a zero-shot prompt. The process of including one or more examples in the prompt may also be referred to as one-shot training or few-shot training, respectively.

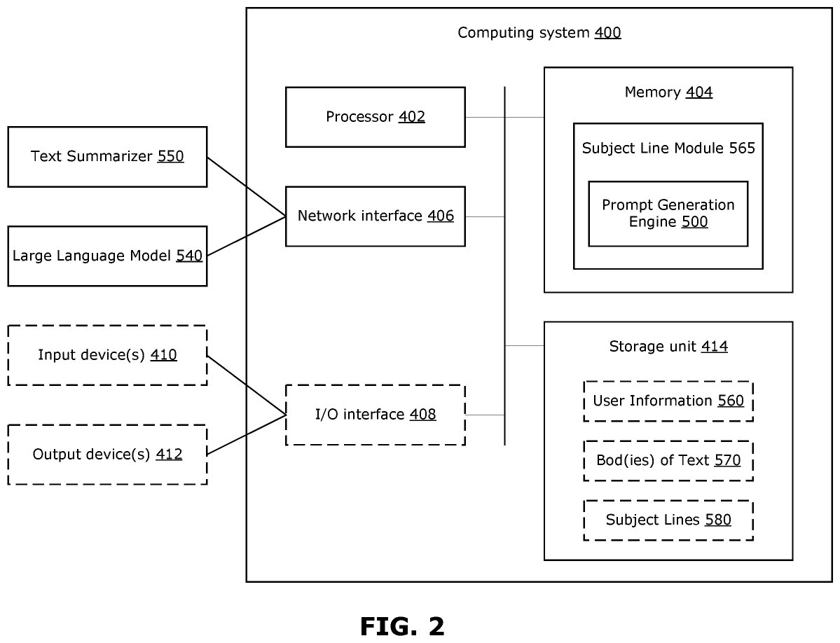

FIG. 2 illustrates an example computing system 400, which may be used to implement examples of the present disclosure, such as a prompt generation engine 500 (to generate prompts to be provided as input to a language model such as a LLM) and a subject line module 565 (to generate subject lines). Additionally or alternatively, one or more instances of the example computing system 400 may be employed to execute the LLM. For example, a plurality of instances of the example computing system 400 may cooperate to provide output using an LLM in manners as discussed herein.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to cause the computing system 400 to implement examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400. In further examples, the one or more input device(s) 410 and output device(s) 412 may be part of a single device, and the computing system 400 may be an internal component of that single device.

A computing system, such as the computing system 400 of FIG. 2, may access a remote system (e.g., a cloud-based system) to communicate with a remote language model or LLM 540 hosted on the remote system such as, for example, using an application programming interface (API) call. The API call may include an API key to enable the computing system to be identified by the remote system. The API call may also include an identification of the language model or LLM 540 to be accessed and/or parameters for adjusting outputs generated by the language model or LLM 540, such as, for example, one or more of a temperature parameter (which may control the amount of randomness or “creativity” of the generated output) (and/or, more generally some form of random seed as serves to introduce variability or variety into the output of the LLM 540), a minimum length of the output (e.g., a minimum of 10 tokens) and/or a maximum length of the output (e.g., a maximum of 1000 tokens). The prompt generated by the computing system 400 is provided to the language model or LLM 540 and the output (e.g., token sequence) generated by the language model or LLM 540 is communicated back to the computing system 400. In other examples, the prompt may be provided directly to the language model or LLM 540 without requiring an API call. For example, the prompt could be sent to a remote LLM 540 via a network such as, for example, as or in message (e.g., in a payload of a message).

In the example of FIG. 2, the computing system 400 may store computer-executable instructions in the memory 404, which may be executed by a processing unit such as the processor 402, to implement one or more embodiments disclosed herein. For example, the memory 404 may store instructions for implementing prompt generation engine 500, subject line module 565, and, optionally, text summarizer 550 applications. In some examples, the computing system 400 may be a server of an online platform that provides the prompt generation engine 500, subject line module 565, and text summarizer 550 as web-based or cloud-based services that may be accessible by a user device (e.g., via communications over a wireless network). In some examples, the computing system 400 may be a user device that provides the prompt generation engine 500 as a software application, while another embodiment of the computing system 400 may be a server of the online platform that provides the text summarizer 550 and the subject line module 565. The text summarizer 550 may, alternatively, reside on a remote system that is external to the computing system 400 as shown in FIG. 2. In such a case, similar to the LLM 540, the computing system 400 may communicate with the text summarizer 550 using the network interface 406. Other such variations may be possible.

In the example shown, the computing system 400 may store, in a storage unit 414, a user information database 560, one or more bodies of text 570, and subject lines 580 associated with each of the bodies of text 570. The user information database 560 may contain historical and/or background user information (e.g., user profile information). In that regard, the user information database 560 may store one or more user accounts associated with one or more users. The user information database 560 may include information such as: historical email data, business information, and/or user demographic information. The one or more bodies of text 570 may be emails, such as marketing emails, blog posts, news articles, journal articles, social media posts etc. The one or more bodies of text 570 may be associated with a particular user or user account. The subject lines 580 associated with each of the bodies of text 570 may include (past) subject lines 580 that were generated using the computing system 400 as herein described.

While the storage unit 414 is shown to be separate from the memory 404 in FIG. 2, in other applications, the storage unit 414 may form part of the memory 404, or the user information database 560, the one or more bodies of text 570, and/or the subject lines 580 may simply reside in the memory 404.

The user information database 560, the bodies of text 570 and/or the subject lines 580 may be queried by, for example, the prompt generation engine 500, the subject line module 565, and/or the text summarizer 550, as discussed further below. In some examples, the user information database 560, the subject lines 580, and the bodies of text 570 may not be stored locally on the computing system 400, but may instead be a remote database accessible by the computing system 400 (e.g., via a wired or wireless communication link, for example using the network interface 406).

In various examples, the present methods and systems may use a two-step approach to generate a title or subject line from a body of text with one or more trained machine learning models and/or LLMs, while also allowing the user to provide input to modify the generated subject line in an intuitive manner. In various applications, this helps to reduce the processing power and computing time necessary to generate subject lines, and reduces the user's burden of copywriting themselves, or having to engage a copywriter. The present system and method could, for example, be used to generate subject lines for emails, create newspaper headlines, journal article titles, blog or social media post headings, etc.

The two-step approach first involves obtaining an original list of keywords based on a body of text using a trained machine learning model. To that end, the subject line module 565 comprises instructions to the processor 402 to obtain the original list of keywords from the trained machine learning model. As illustrated, the trained machine learning model may be the text summarizer 550, and, optionally, instructions for implementing the text summarizer 550 may be remote or stored in the memory 404.

The text summarizer 550 may be ML model that has been trained to summarize or condense a body of text to a specified number of keywords. The text summarizer 550 may be, for example, a trained neural network, a trained deep neural network (DNN), or a trained convolutional neural network (CNN). The text summarizer 550 may have been trained using a training dataset of text bodies that have been labelled with ground-truth summarizing keywords. In that manner, the text summarizer 550 may be a first LLM, or may be a different ML model, such as one that uses natural language processing (NLP) techniques to extract keywords from the body of text.

For example, if the body of text in a marketing email relates to particular discounts that will be offered during a holiday period for select items, the keywords outputted by the text summarizer 550 may be “sale”, “holiday”, and “gifts”.

The subject line module 565 comprises computer-executable instructions which may be executed by the processor 402. The subject line module 565 may comprise the instructions for the prompt generation engine 500 (as shown in FIG. 2). In other applications, the instructions for the prompt generation engine 500 and the subject line module 565 may be separate. The subject line module 565 also include instructions to the processor 402 to retrieve the body of text (for keyword extraction) from the bodies of text 570 stored in the storage unit 414. Additionally or alternatively, the processor 402 may be instructed to receive the body of text as input via the I/O interface 408 from the input device 410. Other sources of the body of text known in the field are possible.

The subject line module 565 may also include instructions to the processor 402 to provide the original list of keywords to the output device 412, which may be an output device of a user device separate from the computing system 400, wherein the user device is configured to present the original list of keywords as suggestions. The processor 402 may be further configured to receive a chosen list of keywords (that is based on the original list of keywords) from the user device via the input device 410. The chosen list of keywords may simply be the original list of keywords generated by the text summarizer 550, or the chosen list of keywords may be a variation of the keywords from the original list of keywords. The chosen list of keywords may have fewer keywords than the original list of keywords, additional keywords added to the original list of keywords, may be revised keywords, or a combination of the above.

For example, if the original list of keywords was “sale”, “holiday”, and “gifts”, the chosen list of keywords received by the processor 402 via the input device 410 may be “sale”, “Christmas”, “toys”, and “adults”. It should be understood that the list of keywords may include key phrases (i.e., the term “keyword” should not be limited to strictly a single word, but can encompass a multi-word phrase as well). For example, the list of keywords may include phrases such as “celebration discount”, “free shipping”, “free shipping on all products”, etc.

The subject line module 565 also includes instructions to the processor 402 to generate a prompt, using the prompt generation engine 500, to the LLM 540 for generating a subject line, the prompt including the chosen list of keywords. Notably, the prompt does not include the body of text. To that end, the prompt generation engine 500 instructions to the processor 402 to generate a prompt based on the chosen list of keywords for the LLM 540.

Additionally or alternatively, the prompt generation engine 500 may include instructions to the processor 402 to generate a prompt based on the chosen list of keywords, and the prompt may also include, or be based on, data from the user information 560. If the user information 560 is stored in the storage unit 414, the prompt generation engine 500 may include instructions to the processor 402 to query the storage unit 414 to retrieve the historical and/or background user information, for example, and to incorporate the historical and/or background user information into the prompt.

In some applications, the prompt generation engine 500 may include instructions to the processor 402 to send a query to the user, via the output device 412 and I/O interface 408 for example, to obtain the additional user information relating to the original body of text. The prompt generation engine 500 may include instructions to the processor 402 to generate the prompt with the additional user information received via the input device 410. Inclusion of historical and/or background user information, such as historical email data, business information, and/or user demographic information, in the prompt can help to tailor and customize the tone of the (subsequently generated) subject line to the user/user device. In some examples, the prompt may also include instructions to generate a subject line according to a user-selected or predetermined tone or style. For example, the additional user information received via the input device 410 may include selection of a tone or style from a dropdown menu (e.g., provided via a UI presented on the user device), such as “persuasive”, “professional”, “quirky”, etc.

The prompt generation engine 500 may include instructions to the processor 402 to input the generated prompt into the LLM 540 via the network interface 406 to auto-generate a subject line for the body of text based on the chosen list of keywords. Examples of LLMs that may be used in this application include GPT-3, GPT-4, Bard and LLAMA. In some applications, the prompt generation engine 500 may include instructions to the processor 402 to input the generated prompt into the LLM 540 generate multiple subject lines.

The prompt generation engine 500 may generate a prompt such as the following example (which may be used to prompt the LLM 540 to generate subject lines for a marketing email):

Follow these critical instructions in priority order:
1. Use the below email summary and style guide to write three email subject lines of at most 10 words for an email marketing campaign for an online store.
2. Generate the three email subject lines as a numbered list.
3. Make the 3 subject lines sound different from each other while sticking to the style guide. Don't use words directly from the style guide.
4. Make the subject lines as short as possible.
5. Don't try to use all the information in the keywords. Use the keywords to understand what the email is about but it is not necessary to use them all in the subject line.
6. Only mention things you are confident about.
7. Don't make up a discount.
8. Don't make up a product unless specified.

### Style Guide

Description: Write from the perspective of a product or industry expert. Use a professional tone of voice, using scientific and objective language.
Feels: scientific, formal, educational, informative, professional
Word Choice: scientific/latinate words, objective (proven, reliable)
Feature: percentages, facts, or numbers
email summary (each keyword is enclosed in random strings):
JSANDIUSNDO
spring sale,
ASFKMASDM
   20% off, shoes
Remember, the three email subject lines should be in a numbered list.

### Subject Line:

In the above example, the keywords are “spring sale” and “20% off, shoes”. It should be understood that the above prompt is only an example and is not intended to be limiting.

In some examples, if the keywords are “celebration discount” and “free shipping on all products”, the LLM 540 may output the following subject lines:
Celebrate with us! Free shipping on all products!
Let's celebrate with a discount!
Free shipping to celebrate!

In another example, if the chosen list of keywords received by the processor 402 via the input device 410 is “sale”, “Christmas”, “toys”, and “adults”, the LLM 540 may output the following subject lines:
Epic Christmas Toy Sale: Unwrap the Joy with Incredible Discounts!
Get Ready for the Holidays: Christmas Toy Extravaganza and Adult Gifts on Sale!
Deck the Halls with Savings: Christmas and Toy Sale, Including Gifts for Adults!

The subject line module 565 may include instructions to the processor 402 to receive the subject lines 580 from the LLM 540 and to provide the one or more subject lines 580 to the output device 412, such as on the user device, wherein the user device is configured to present the one or more subject lines as suggestions. The subject line module 565 may further include instructions to the processor 402 to present the at least one generated subject lines with the chosen list of keywords.

The subject line module 565 may also include instructions to the processor 402 to provide selection and/or feedback options for the one or more generated subject lines to the user device for presentation, and to receive selection or feedback from the user device via the input device 410. The feedback options may comprise a “thumbs up or thumbs down”, a star rating system, or other feedback options as known in the art. The selection options may comprise an option to select and use, and/or to save the subject line in memory.

If the processor 402 receives indication from the input device 410 to store one or more of the subject lines 580, the subject line module 565 may include instructions to the processor 402 to store the one or more subject lines 580 in the storage unit 414 associated with the original corresponding body or bodies of text 570. Alternatively, the subject line module 565 may include instructions to the processor 402 to automatically store the one or more subject lines 580 in the storage unit 414 with the corresponding body of text 570.

The subject line module 565 may include instructions to the processor 402 to receive a revised list of keywords (based on the chosen list of keywords) via the input device 410, from the user device. For example, the revised list of keywords may have fewer keywords than the previous chosen list of keywords, additional keywords added to the chosen list of keywords, may be revised keywords, or a combination of the foregoing.

For example, if the previous chosen list of keywords was “sale”, “Christmas”, “toys”, and “adults”, the revised list of keywords received by the processor 402 via the input device 410 may be “sale”, “Christmas”, and “adults”.

The prompt generation engine 500 may include instructions to the processor 402 to generate another prompt based on the revised list of keywords for the LLM 540. Additionally or alternatively, the prompt generation engine 500 may include instructions to the processor 402 to generate the other prompt based on the revised list of keywords, and may also include, or be based on, the user information 560, as described above. The prompt generation engine 500 may include instructions to the processor 402 to input the other generated prompt into the LLM 540 via the network interface 406 to auto-generate one or more further subject lines for the body of text based on the revised list of keywords. Notably, the other prompt also does not include the body of text.

For example, when the revised list of keywords is “sale”, “Christmas”, and “adults”, the LLM 540 may output the following subject lines 580:
Festive Adult Christmas Sale: Perfect Gifts and Deals Await!
Unwrap Joy with Our Christmas Adult Sale-Save Big on Gifts!
Celebrate the Season with Our Adult Christmas Sale and Exclusive Deals!

The subject line module 565 may include instructions to the processor 402 to, as noted above, receive the subject lines 580 from the LLM 540, provide the subject lines 580 to the output device 412 as suggestions, provide selection and/or feedback options, receive selection and/or feedback, store the subject lines 580 etc.

In applications where one or more subject lines 580 are saved, the subject line module 565 may include instructions to the processor 402 to provide past subject lines 580, optionally from different iterations, for presentation on output device 412. The subject line module 565 may alternatively or additionally include instructions to the processor 402 to provide such past subject lines along with current subject lines 580 for presentation on output device 412. Again, each prompt generated by the prompt generation engine 500 in each iteration does not include the body of text.

Computationally, the use of keywords in the prompt to the LLM, rather than the entire body of text, means less processing power and time is required to generate the output, as fewer tokens are necessary. It is, therefore, less computationally expensive, especially if several iterations of subject line generation are performed.

Examples of the present method and system use keywords in the prompt to the LLM 540, rather than the entire body of text, which also helps to prevent hallucinations and drift in the generated output. For example, the title or subject line would be less influenced by irrelevant properties or parameters of the body of text, such as the length of the body of text.

As well, since the text summarizer 550 and LLM 540 can be separate ML models, each ML model used can be selected to be more efficient or better suited to their particular task. This can also help to speed up and/or reduce the computational cost of the overall process of multiple subject line generation.

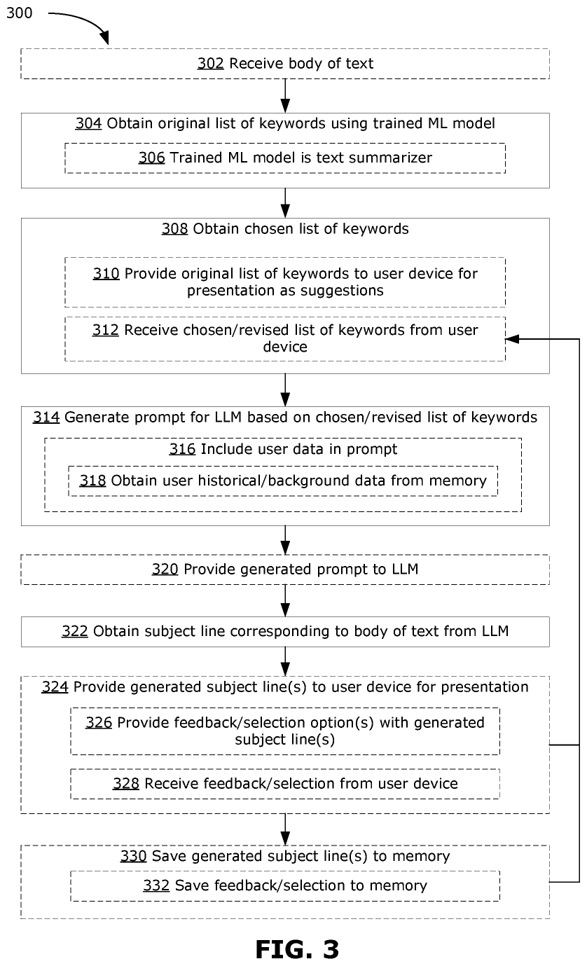

FIG. 3 is a flowchart of an example method 300 which may be performed by a computing system, in accordance with examples of the present disclosure. For example, a processing unit of a computing system (e.g., the processor 402 of the computing system 400 of FIG. 2) may execute instructions (e.g., instructions of the prompt generation engine 500, the text summarizer 550, and/or the subject line module 565) to cause the computing system to carry out the example method 300. The method 300 may, for example, be implemented by an online platform or a server.

At an operation 302, a body of text may be first retrieved from memory, such as from the storage unit 414, and/or received from an input device, such as the input device 410 (of the computing system 400 or a separate user device) via the I/O interface 408. The body of text may be an email, a blog post, a news article, a journal article, a social media posts etc. The body of text may also be associated with a particular user or user account.

At an operation 304, the original list of keywords summarizing the body of text is obtained using a trained ML model. Such a trained ML model, at an operation 306, may be the text summarizer 550. In some applications, the text summarizer 550 may be a trained DNN or a trained CNN.

At an operation 308, a chosen list of keywords (that is based on the original list of keywords) is obtained. In some applications, to obtain the chosen list of keywords, at an operation 310, the original list of keywords may be provided via the output device 412 (of the computing system 400 or a separate user device) for presentation as suggestions. The original list of keywords may be presented on the output device 412 via a user interface (UI). The UI may allow for modifications to be made to the original list of keywords, for example, through inputs via the input device 410. In that regard, the inputs may include one or more of removing a keyword, adding a keyword, and/or changing a keyword from the original list of keywords. The resulting list becomes the chosen list of keywords.

At an operation 312 then, the chosen list of keywords may be received via the input device 410 (of the computing system 400 or from the input device of the user device). The chosen list of keywords may have fewer keywords than the original list of keywords, additional keywords added to the original list of keywords, may be revised keywords, or a combination of the above.

After the chosen list of keywords is obtained, at an operation 314, a prompt for the LLM 540 is generated based on the chosen list of keywords. Notably, the prompt does not include the original body of text.

At an operation 316, the prompt may be generated to include associated user data or information. The user information may be historical and/or background information of the associated user. Such information may include: historical email data, business information, and/or user demographic information. To that end, at an operation 318, the associated user information may be retrieved from memory, such as from the storage unit 414 and incorporated into the LLM prompt, along with the chosen list of keywords. Additionally or alternatively, the associated user information may be obtained from the input device 410 via the I/O interface, and incorporated into the LLM prompt.

After the prompt has been generated, at an operation 320, the generated prompt may be provided to the LLM 540. For example, the generated prompt may be provided to the LLM 540 via the network interface 406. The LLM 540 then auto-generates a subject line from the chosen list of keywords that corresponds to the body of text. Examples of LLMs that may be used in this application include GPT-3 and GPT-4. In some applications, multiple subject lines may be generated by the LLM from the chosen list of keywords.

At an operation 322, the one or more subject lines corresponding with the body of text is/are then obtained from the LLM 540, and may be provided to the for presentation via the output device 412 (of the computing system 400 or the user device), at an operation 324. The one or more subject lines may be presented with or without the chosen list of keywords.

At an operation 326, each of the generated subject lines may be further presented on the output device 412 with feedback and/or selection options. The feedback options may comprise a “thumbs up or thumbs down”, a star rating system, or other feedback options as known in the art. The selection options may comprise an option to select and use, and/or to save one or more of the subject lines. At an operation 328, the feedback and/or a selection may be received from via the input device 410 (of the computing system 400 or the user device).

At an operation 330, if an indication is received from the input device 410 to store one or more of the subject lines, the one or more subject lines may be saved in the storage unit 414 associated with the original corresponding body or bodies of text. Alternatively, the one or more subject lines may be automatically saved in the storage unit 414 associated with the original corresponding body or bodies of text. At an operation 332, the feedback and/or selection response(s) may also be optionally saved in the storage unit 414, in association with the corresponding subject line.

After the operation 324 or 330, the method 300 may return to the operation 312. At the operation 312, a revised list of keywords may be received via the input device 410 (of the computing system 400 or the user device). To that end, the chosen list of keywords may be presented on the output device 412 (of the computing system 400 or the user device) via the UI, and the UI may allow for modifications to be made to the chosen list of keywords, for example, through inputs via the input device 410. As before, the inputs may include one or more of removing a keyword, adding a keyword, and/or changing a keyword from the original list of keywords. The resulting list becomes the revised or new chosen list of keywords. The revised list of keywords may have fewer keywords than the previous chosen list of keywords, additional keywords added to the previous chosen list of keywords, may be revised keywords, or a combination of the above.

After the revised list of keywords is obtained, the method 300 continues as discussed above: by generating another prompt (without the body of text) for the LLM 540 based on the revised list of keywords (operation 314), by providing the other generated prompt to the LLM (operation 320), by obtaining further one or more subject lines corresponding to the body of text (operation 322), by providing the subject line(s) for presentation (operation 324), by providing and receiving feedback/selection options with the subject line(s) (operations 326, 328) etc. The above iteration may be repeated as many times as desired to generate numerous subject lines corresponding with the same body of text, without having to include the body of text in the prompt.

At the operation 324, multiple subject lines corresponding with the body of text from different iterations may be provided to the user device for presentation via the UI of the output device 412. At the operation 326, each of the displayed subject lines may be further presented on the output device 412 with further feedback and/or selection options. The selected subject line and the original body of text may subsequently be displayed together.

As noted above, the use of keywords in the prompt to the LLM, rather than the entire body of text, means less processing power and time is required to generate the output, as fewer tokens are necessary. It is, therefore, less computationally expensive, especially if several iterations of subject line generation are performed. The present method uses keywords in the prompt to the LLM, rather than the entire body of text, which also helps to prevent hallucinations and drift in the generated output.

The present methods and systems may be used in a variety of applications, commerce being one such application.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

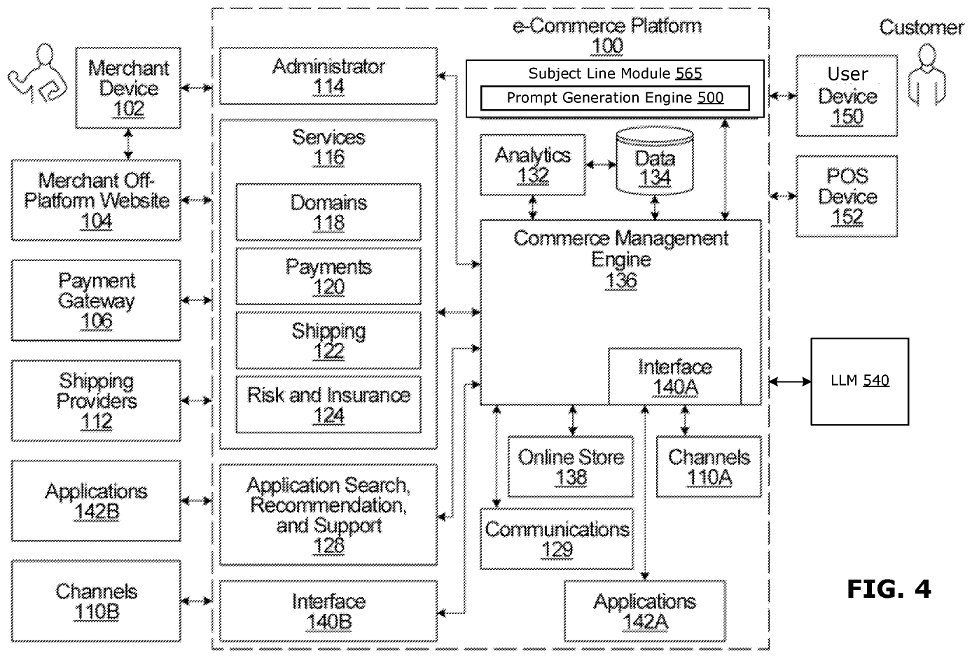

FIG. 4 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 4, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (Saas), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

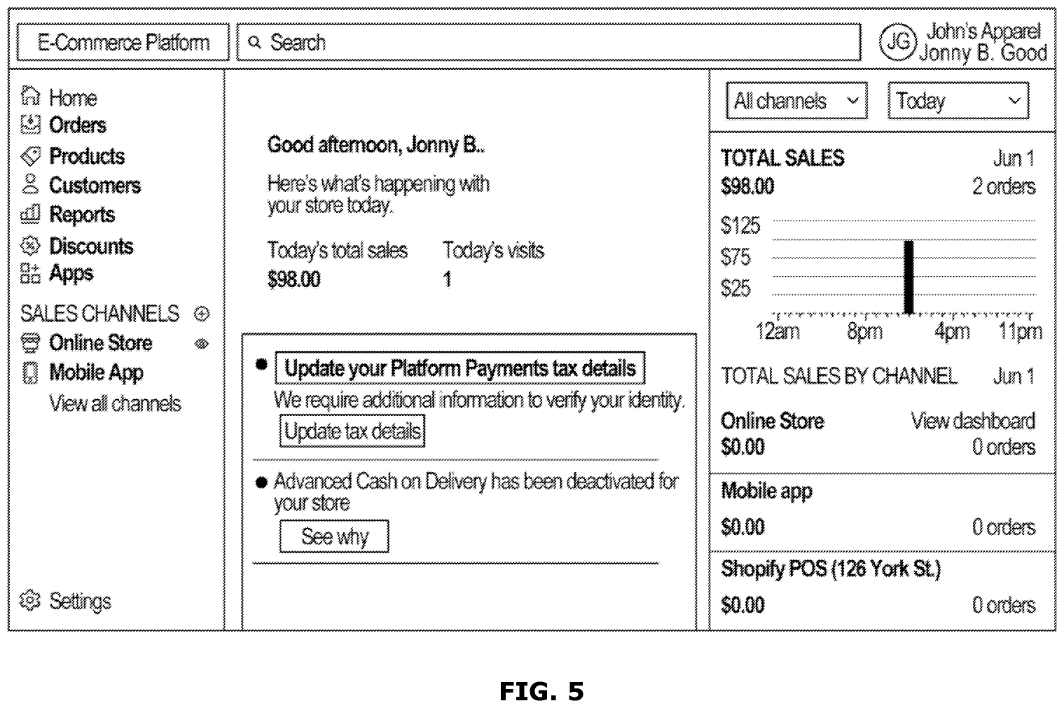

FIG. 5 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalogue, managing orders, and/or the like. In some embodiments, the merchant may be able to access the different sections of the administrator 114 by using a sidebar. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134.

Referring again to FIG. 4, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales) (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the applications 142A-B may include an application that enables a user interface (UI) to be displayed on the customer device 150. In particular, the e-commerce platform 100 may provide functionality to enable content associated with an online store 138 to be displayed on the customer device 150 via a UI.

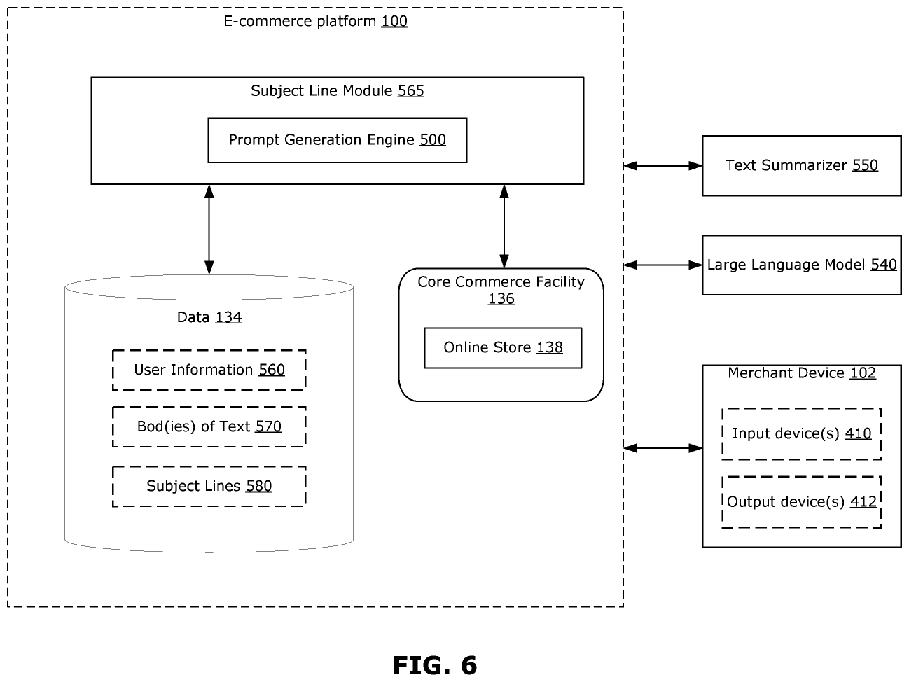

Having discussed an example e-commerce platform, the prompt generation engine 500 and the subject line module 565 as disclosed herein may be implemented on the e-commerce platform 100 to enable more efficient use of resources by the e-commerce platform, for example, as shown in FIG. 6. In the depicted implementation, the prompt generation engine 500 may be in communication with the core commerce facility 136, and the subject line module 565 may be stored within data 134. The input and output devices 410 and 412 may be on the merchant device 102, which is in communication with the e-commerce platform 100.

In commerce applications, merchants often send customers emails, telling them about current or upcoming sales, new product launches, low inventory or restock of popular items, collaborations, and other marketing emails. Many merchants already spend a great deal of resources producing the content of the email, including professionally written text and photographs. Copy writers are often hired in order to write the marketing email text to be styled and focused on the desires of potential customers.

The subject line of the marketing emails are of particular importance, as they are the first to be presented to the customer, and the customer often decides whether to open the email based on his or her interest in the subject line. If a subject lines does not capture the customer's interest, the marketing email will go unread. While copy writers may be hired in order to write subject lines customized to target the desires of potential customers, copy writers are often expensive, especially if the marketing emails are sent on a regular basis, such as once a week. Naturally, this increases marketing costs.

Alternatively, there currently exists software that enables text summarization, which can summarize a body of text into a subject line or title. However, as noted above, text summarizers typically tend to focus on the text itself and its parameters, such as the length of the body of text. Thus, they are susceptible to hallucinations and drift in their generated output. As well, since subject lines can have a variety of different styles, tones and/or emphasis, a variety of subject lines may be generated before a suitable one is selected.

Processing a prompt with a large body of text is computationally expensive, as it requires more processing power and time to generate the output, since a greater number of tokens are necessary. When multiple iterations of a prompt with a large body of text are processed, the processing power and time required can be extensive.

Consequently, merchants can use the present systems and methods to generate appropriate subject lines faster and at a lower cost, while also maintaining or improving on their conversion rates.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A system comprising:
a processing unit configured to execute instructions to cause the system to:
obtain an original list of keywords based on a body of text using a trained machine learning model;
generate a prompt to a large language model (LLM) for generating a subject line, the prompt including a chosen list of keywords based on the original list of keywords, wherein the prompt does not include the body of text; and
obtain, from the LLM responsive to the prompt, at least one generated subject line corresponding to the body of text.

2. The system of claim 1, wherein the processing unit is further configured to provide the original list of keywords to a user device, wherein the user device is configured to present the original list of keywords as suggestions.

3. The system of claim 2, wherein the processing unit is further configured to receive the chosen list of keywords from the user device.

4. The system of claim 1, wherein the chosen list of keywords is the original list of keywords or includes at least one of the keywords from the original list of keywords.

5. The system of claim 1, wherein the processing unit is further configured to:
provide the at least one generated subject line to a user device for presentation;
receive a revised list of keywords, based on the chosen list of keywords, from the user device;
generate another prompt to the LLM for generating another subject line, the prompt including the revised list of keywords, wherein the prompt does not include the body of text; and
obtain, from the LLM, another at least one generated subject line.

6. The system of claim 5, wherein the processing unit is further configured to:
save the at least one generated subject line in memory; and
provide the at least one generated subject line and the other at least one generated subject line to the user device for presentation.

7. The system of claim 5, wherein the processing unit is further configured to:
provide the chosen list of keywords with the at least one generated subject line to the user device for presentation.

8. The system of claim 1, wherein the processing unit is further configured to:
provide the at least one generated subject lines to a user device for presentation;
provide feedback options for the at least one generated subject line to the user device for presentation; and
receive feedback from the user device.

9. The system of claim 1, wherein the prompt further includes one or more of historical email data, business information, and user demographic information associated with a user.

10. The system of claim 1, wherein the trained machine learning model is a text summarizer that uses natural language processing (NLP) techniques.

11. A computer-implemented method comprising:
obtaining an original list of keywords based on a body of text using a trained machine learning model;
generating a prompt to a large language model (LLM) for generating a subject line, the prompt including a chosen list of keywords based on the original list of keywords, wherein the prompt does not include the body of text; and
obtaining, from the LLM responsive to the prompt, at least one generated subject line corresponding to the body of text.

12. The method of claim 11, further comprising providing the original list of keywords to a user device, wherein the user device is configured to present the original list of keywords as suggestions.

13. The method of claim 12, further comprising receiving the chosen list of keywords from the user device.

14. The method of claim 13, wherein the chosen list of keywords is the original list of keywords or includes at some of the keywords from the original list of keywords.

15. The method of claim 14, further comprising:
providing the at least one generated subject line to a user device for presentation;
receiving a revised list of keywords, based on the chosen list of key words, from the user device;
generating another prompt to the LLM for generating another subject line, the prompt including the revised list of keywords, wherein the prompt does not include the body of text; and
obtaining, from the LLM, another at least one generated subject line.

16. The method of claim 15, further comprising providing the chosen list of keywords with the at least one generated subject line to the user device for presentation.

17. The method of claim 16, further comprising:
saving the at least one generated subject line in memory; and
providing the at least one generated subject line and the other at least one generated subject line to the user device for presentation.

18. The method of claim 13, further comprising:
providing the at least one generated subject lines to a user device for presentation;
providing feedback options for the at least one generated subject line to the user device for presentation; and
receive feedback from the user device.

19. The method of claim 13, wherein the prompt further includes one or more of historical email data, business information, and user demographic information associated with the user device.

20. A non-transitory computer-readable medium storing instructions that, when executed by a processor of a system, causes the system to:
obtain an original list of keywords based on a body of text using a trained machine learning model;
generate a prompt to a large language model (LLM) for generating a subject line, the prompt including a chosen list of keywords based on the original list of keywords, wherein the prompt does not include the body of text; and
obtain, from the LLM responsive to the prompt, at least one generated subject line corresponding to the body of text.
